(19) United States
(12) Patent Application Publication
(10) Pub. No.: US 2026/0146677 A1
(43) Pub. Date: May 28, 2026

(54) Directional Valve for a Heat Pump and Heat Pump

(71) Applicant: Viessmann Holding International GmbH, Allendorf (Eder) (DE)

(72) Inventor: Christian STÖCKEL, Dresden (DE)

(21) Appl. No.: 19/376,947

(22) Filed: Nov. 1, 2025

(30) Foreign Application Priority Data
Nov. 25, 2024 (DE) 10 2024 134 679.5

(51) Int. Cl. F16K 11/07; F16K 3/314; F16K 31/06; F24F 3/00; F24F 11/84

(52) U.S. Cl. CPC F16K 11/0716; F16K 3/314; F16K 31/0675; F24F 3/001; F24F 11/84

(57) ABSTRACT

The present invention relates to a directional valve for a heat pump for heating and cooling a building, as well as a heat pump with a directional valve. The directional valve according to the invention comprises a valve housing with a plurality of ports; a valve slider with a plurality of flow channels; at least one electromagnet configured to move the valve slider to a first position; a switching element configured to move the valve slider to a second position; a first line connecting a first chamber formed adjacent to a first end face of the valve slider in the valve housing to a first port of the valve housing; and a second line connecting a second chamber formed adjacent to a second end face of the valve slider in the valve housing to a second port of the valve housing.

### BACKGROUND OF THE INVENTION

The present invention relates to a directional valve for a heat pump for heating and cooling a building, as well as a heat pump with a directional valve and a method for refrigerant circuit reversal by means of a directional valve.

Heat pumps allow the use of freely available energy from the environment for heating and/or cooling a building, thus contributing to the reduction of CO₂ emissions in the building sector. In particular, a heat pump can be used for both heating and cooling, since heat exchangers included therein can be used as both evaporators and condensers. For example, by reversing the refrigerant circuit, a heat exchanger that functions as a condenser in heating mode can function as an evaporator in cooling mode and vice versa, whereby, for example, a secondary circuit of the corresponding heat exchanger can release heat to the building in heating mode and absorb heat from the building in cooling mode.

A reversal of the refrigerant circuit can also be used to eliminate icing of a heat exchanger in an outdoor unit of an air-to-water heat pump working as an evaporator in heating mode. This can occur under certain weather conditions, especially at ambient temperatures below 7° C. to 10° C. In this case, the refrigerant circuit reversal causes heat, e.g., from a heating/cooling circuit in the building, to be supplied to defrost the heat exchanger, which then functions as a condenser.

For refrigerant circuit reversal, a 4/2 directional valve is usually used, which is actuated by a pilot valve.

For example, JP 6 261 008 B2 shows a 4/2 directional valve with a cylindrical valve housing and a valve slider slidably arranged in the valve housing. The valve housing has an inlet port on one side, which is connected to a pressure side of a compressor in a refrigerant circuit. Three further ports are arranged on a radially opposite side of the valve housing, a central of which is permanently connected to a suction side of the compressor. The two outer ports are each connected to a first and second heat exchanger respectively in the refrigerant circuit. A bore is arranged in the valve slider, by means of which one of the two outer ports of the valve housing can be connected to the middle port depending on the position of the valve slider (first or second position). In this way, a flow direction of the refrigerant through the two heat exchangers can be reversed. A corresponding adjustment of the valve slider is controlled by a pilot valve, which is formed as a solenoid valve. The pilot valve is connected on an inlet side to the pressure side of the compressor and has two ports on an outlet side, each of which is connected to a chamber in the valve housing that is adjacent to an end face of the valve slider. By energizing the pilot valve, one of the two outputs is connected to the inlet side, so that one of the two chambers is pressurized and the valve slider is moved to the first or second position.

However, in case of 4/2 directional valves that are actuated by a pilot valve as described above, the compressor must always provide a sufficiently high pressure difference between the compressor inlet and outlet in order to move the valve slider from one position to the other. If this is not the case, the valve slider may not be moved completely, meaning that the desired ports are not connected or are only partially connected. This can lead to significant disruptions in the operation of the refrigerant circuit.

It is an object of the present invention to overcome the disadvantages described above and to provide a directional valve that ensures reliable adjustment of the valve slider to a desired position at all times.

In order to solve the objects, the features of the independent claims are proposed. Advantageous embodiments can be found in the dependent claims.

### DISCLOSURE OF THE INVENTION

A heat pump according to the invention for heating and cooling a building comprises a refrigerant circuit with a first heat exchanger, a compressor, a second heat exchanger, an expansion element and a directional valve according to the invention as described below.

In particular, the heat pump may be designed as an air-to-water heat pump. The first heat exchanger of the refrigerant circuit may use ambient air as a heat source and heat sink, while the second heat exchanger may use a heating/cooling circuit of the building as a heat source and heat sink. In particular, the first heat exchanger may be a finned heat exchanger, and the second heat exchanger may be, for example, a plate heat exchanger whose secondary side is connected to the heating/cooling circuit of the building. In particular, the air-to-water heat pump may be of monobloc design, in which the first and second heat exchangers are located in a single unit. The unit may be located inside the building or preferably outside the building.

It is also possible that the heat pump is designed as an air-to-air heat pump. In this case, the first heat exchanger may be arranged in an outdoor unit, for example, and use ambient air as a heat source and heat sink. The second heat exchanger may be arranged in an indoor unit, for example, and use ambient air from the building as a heat source and heat sink. In particular, the indoor unit may be designed as a fan coil.

To heat the building (heating mode of the heat pump), the first heat exchanger may function as an evaporator and the second heat exchanger as a condenser, and to cool the building (cooling mode of the heat pump), the second heat exchanger may function as an evaporator and the first heat exchanger as a condenser. In order to switch from heating mode to cooling mode of the heat pump and vice versa, the directional valve may switch the flow direction of the refrigerant circuit. Furthermore, the directional valve may switch the direction of flow of the refrigerant circuit in order to cause the first heat exchanger to defrost.

The compressor of the refrigerant circuit may be arranged between the first heat exchanger and the second heat exchanger, while the expansion element may be arranged between the second heat exchanger and the first heat exchanger. In other words, in heating mode of the heat pump, the compressor may be arranged downstream of the first heat exchanger and upstream of the second heat exchanger, and the expansion element may be arranged downstream of the second heat exchanger and upstream of the first heat exchanger. In cooling mode, by contrast, the compressor may be arranged downstream of the second heat exchanger and upstream of the first heat exchanger, and the expansion element may be arranged downstream of the first heat exchanger and upstream of the second heat exchanger. In particular, the compressor may be a variable speed compressor, and the expansion element may be a thermostatic or electronic expansion valve.

The function of the refrigerant circuit described above with the mentioned components is explained in more detail below in conjunction with the figures.

The directional valve according to the invention for a heat pump for heating and cooling a building, as described above, comprises a valve housing with a plurality of ports and a valve slider with a plurality of flow channels, which is arranged axially movable in the valve housing. The term “axial” in the present case is meant to designate a direction along or parallel to a center axis of the directional valve, while the term “radial” is meant to designate a direction perpendicular to the center axis. The plurality of ports may be arranged on an outer surface of the valve housing, and each port may include an opening that can be brought into overlap with a cross-section of one of the plurality of flow channels to pass refrigerant through the directional valve.

According to an embodiment, the valve slider may have three flow channels. In this case, the valve housing may expediently have at least four ports, of which a first port may be connected to the second heat exchanger and a second port to the first heat exchanger of the refrigerant circuit of the heat pump.

According to an embodiment, a third port of the valve housing may be connectable to a high-pressure side, and a fourth port of the valve housing may be connectable to a low-pressure side of the heat pump. In other words, the third port can be connected to an outlet or a pressure side of the compressor, and the fourth port can be connected to an inlet or a suction side of the compressor. In particular, the third and fourth ports may be arranged radially opposite each other on the outer surface of the valve housing. Among the three flow channels of the valve slider, two may be used to connect the first or second heat exchanger to the high-pressure side of the heat pump, while one may be used to connect the other of the two heat exchangers to the low-pressure side of the heat pump. For this purpose, each of the first and second ports may be arranged in the axial direction next to the fourth port. In particular, the fourth port may be located between the first and second ports.

In an embodiment, the valve slider may be designed as a piston slider, in the cylindrical body of which, e.g. the three flow channels may be formed. In this case, the valve housing may expediently have a cylinder in which the piston slide can be displaced in the axial direction. Alternatively, the valve slider may be designed as a shell valve, as shown, for example, in JP 6 261 008 B2.

Therefore, the directional valve includes at least one electromagnet configured to move the valve slider to a first position. The electromagnet has an armature that is mechanically connected to the valve slider. In addition, the electromagnet may comprise a solenoid coil that at least partially surrounds the armature. The armature of the electromagnet may be mechanically operatively connected to the valve slider in such a way that energizing the solenoid coil leads to an axial movement or axial displacement of the valve slider into the first position in the valve housing. For example, energizing the solenoid coil can initiate an axial movement of the armature, which may then come into mechanical contact with the valve slider and cause its axial movement. The electromagnet may therefore be arranged on a first end face of the cylindrical valve housing body, for example, and its armature may be adjacent to a first end face of the valve slider. It is also possible that the armature is mechanically connected to the first end face of the valve slider, e.g. by means of a screw connection or a weld. Alternatively, the armature and the valve slider may be designed in one piece.

According to an embodiment, the valve slider when in the first position may be configured to connect the first port of the valve housing to a high-pressure side and the second port of the valve housing to a low-pressure side of the heat pump. In particular, in the first position of the valve slider, its flow channels may be arranged in such a way that an output of the first heat exchanger is connected to the input of the compressor via the second and fourth ports of the valve housing, and the output of the compressor is connected to an input of the second heat exchanger via the third and first ports of the valve housing.

In addition, the directional valve has a switching element configured to move the valve slider to a second position. According to an embodiment, the valve slider when in the second position may be configured to connect the first port of the valve housing to the low-pressure side and the second port of the valve housing to the high-pressure side of the heat pump. In particular, in the second position of the valve slider, its flow channels may be arranged in such a way that the output of the compressor is connected to an input of the first heat exchanger via the third and second ports of the valve housing, and an output of the second heat exchanger is connected to the input of the compressor via the first and fourth ports of the valve housing. Since a movement of the valve slider from the first to the second position causes a reversal of the refrigerant flow, the inlet and outlet of the first and second heat exchanger may each be the same port, which serves as an inlet in one case and as an outlet in the other case.

According to an embodiment, the switching element may comprise an electromagnet. In particular, the directional valve may include a second electromagnet with a solenoid coil and an armature, which may be arranged axially opposite the first electromagnet, for example on a second end face of the cylindrical valve housing body. In this case, the armature of the second electromagnet may be mechanically operatively connected to the valve slider in such a way that energization of the solenoid coil causes an axial movement or axial displacement of the valve slider into the second position in the valve housing. For example, energizing the solenoid coil can initiate an axial movement of the armature, which may then come into mechanical contact with the valve slider and causes its axial movement. It is also possible that the armature is mechanically connected to the valve slider, e.g. by means of a screw connection or a weld. Alternatively, the armature and the valve slider may be designed in one piece.

The axial movement that moves the valve slider to the second position may be opposite to the axial movement that moves the valve slider to the first position.

Alternatively or in addition, the switching element may comprise at least one spring which is adjacent to a second end face of the valve slider, axially opposite its first end face. The at least one spring may move the valve slider to the second position when the first opposite electromagnet is switched off and a compressive force acting on the first end face is less than a spring force of the spring. The at least one spring may, in particular, be a coil spring. It is also possible that multiple springs are used as switching elements.

A first chamber is formed in the valve housing adjacent to the first end face of the valve slider and a second chamber is formed adjacent to the second end face of the valve slider. The first chamber is connected to the first port of the valve housing via a first line, and the second chamber is connected to the second port of the valve housing via a second line. The first and second lines may, for example, be designed as capillary tubes. In this way, a pressure applied to the first port acts on the first end face (first control surface) of the valve slider in the first chamber and a pressure applied to the second port acts on the second end face (second control surface) of the valve slider in the second chamber.

In an embodiment, one or multiple seals may be positioned on the valve slider to seal the first and second chambers in the valve housing. Expediently, e.g. at least one radial seal may be fitted on a circumference of the valve slider that adjoins or connects to one of its end faces. It is also possible for the first and second chambers to be sealed in the housing by means of at least one axially arranged seal. In addition, the individual flow channels may be provided with seals to also seal them separately in the housing.

In the first position of the valve slider, the first port of the valve housing is connected to the high-pressure side, and the second port of the valve housing is connected to the low-pressure side of the heat pump. As a result, in this position there is high pressure in the first chamber and low pressure in the second chamber, so that the valve slider is held in the first position by the existing pressure gradient. This means that the electromagnet only needs to be switched on/activated to adjust the valve slider and may be switched off/deactivated as soon as the valve slider has reached the first position.

In the second position of the valve slider, the first port of the valve housing is connected to the low-pressure side, and the second port of the valve housing is connected to the high-pressure side of the heat pump. Consequently, in this position there is high pressure in the second chamber and low pressure in the first chamber, which holds the valve slider in the second position. In this case, the switching element only needs to be active until the valve slider has reached the second position. If a second electromagnet is used as a switching element, it may only be switched on/activated for the duration of one adjustment travel of the valve slider. If a spring is used as a switching element, its spring force is also only required for the adjustment travel of the valve slider, since the pressure gradient between the two chambers subsequently holds the valve slider in the second position. In particular, the spring force may already be supported by a compressive force in the second chamber during the adjustment procedure as soon as part of a cross-section of the corresponding flow channel is released through an opening of the second and third ports.

In this way, a flow direction in a refrigerant circuit of a heat pump for heating and cooling a building may be reliably switched when a demand for reversing the flow direction is detected. Furthermore, a position of the valve slider may only be maintained by the pressure gradient between the high-pressure and low-pressure sides of the heat pump, and in particular no additional electrical energy, e.g. for actuating a pilot valve, is required. The use of an electromagnet with an armature that is mechanically operatively connected to the valve slider also allows the directional valve to be switched even when the compressor is at a standstill. This may be advantageous, for example, when the heat pump is operated intermittently in summer, e.g. when it is only used temporarily for cooling and hot water preparation. In this case, the directional valve may already be moved to the desired position before the compressor is switched on, thereby accelerating activation of the refrigerant circuit.

According to a further embodiment, at least two valve sliders may be arranged in the valve housing. In particular, these may be of identical design and each may comprise, e.g., three flow channels as described above. In this case, the valve housing may expediently have at least eight ports. In particular, each valve slider with three flow channels may be assigned four ports each, which may be arranged on the outer surface of the valve housing as described above. The two valve sliders may be configured to switch a flow direction in a refrigerant circuit with two-stage compression and intercooler for example. This is explained in more detail below in connection with the figures. In particular, the two valve sliders may also be used to switch a refrigerant circuit as described in EP 24 15 4257, the expansion section of which is flowed through in the same direction both in heating mode and in cooling mode. The subject matter of patent application EP 24 15 4257 is hereby incorporated by reference in its entirety.

In particular, the at least two valve sliders may have a common center axis and may each be adjacent to one another with one of their end faces. In other words, the at least two valve sliders may be arranged directly next to each other in a longitudinal section through the directional valve. When using two valve sliders, a different end face of the respective valve slider may adjoin the armature of the electromagnet or the switching element. In particular, the at least two valve sliders may be moved to the first position by a common electromagnet and to the second position by a common switching element.

According to an embodiment, the flow channels of the at least two valve sliders may be fluidically separated from one another by means of at least one seal. For example, at least one radial seal may be fitted to at least one circumference of the valve slider that adjoins the two adjacent end faces. It is also possible that the flow channels of the at least two valve sliders are fluidically separated from each other by means of at least one axially arranged seal. In addition, the individual flow channels may be provided with seals in order to also seal them separately in the housing.

In an embodiment, the at least two valve sliders may be connected to each other. For example, the valve sliders may be screwed, glued, welded, pressed or connected to each other in any other suitable way.

In particular, the at least two valve sliders may be designed as a common component. In this case, the valve sliders may expediently be manufactured in one piece. The arrangement of at least two valve sliders in one valve housing allows multiple valve functions to be provided with just one control mechanism (electromagnet and switching element). In this way, for example, a flow direction of a refrigerant circuit with two-stage charging and intercooling may be reversed reliably and efficiently. Alternatively, the directional valve with two valve sliders may also be used to switch a refrigerant circuit as described in EP 24 15 4257, whose expansion section is flowed through in the same direction both in heating mode and in cooling mode.

### BRIEF DESCRIPTION OF THE FIGURES

FIG. 1 schematically shows a refrigerant circuit of a heat pump for heating and cooling a building in which a directional valve according to the invention can be used.

FIG. 2 shows a directional valve according to an exemplary embodiment of the invention in a schematic longitudinal sectional view.

FIG. 3 shows a directional valve according to a further exemplary embodiment of the invention in a schematic longitudinal sectional view.

FIG. 4a schematically shows a flow path through the directional valve from FIG. 2 when its valve slider is in a first position.

FIG. 4b schematically shows a flow path through the directional valve from FIG. 2 when its valve slider is in a second position.

FIG. 5 shows a directional valve according to a further exemplary embodiment of the invention in a schematic longitudinal sectional view.

FIG. 6a shows schematic flow paths through the directional valve from FIG. 5 when its valve sliders are in the first position.

FIG. 6b shows schematic flow paths through the directional valve from FIG. 5 when its valve sliders are in the second position.

### DETAILED DESCRIPTION OF PREFERRED EXEMPLARY EMBODIMENTS

In the following, exemplary embodiments of the present invention are described in detail with reference to exemplary figures. The features of the exemplary embodiments are combinable in whole or in part, and the present invention is not limited to the described exemplary embodiments. In the figures, identical or similar elements are provided with identical reference signs, so that a repeated description of the elements is omitted if this is not necessary.

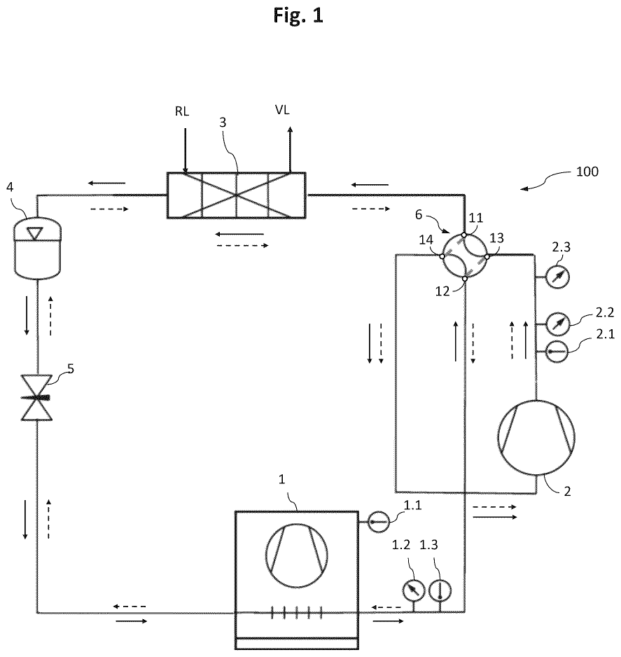

FIG. 1 schematically shows a refrigerant circuit 100 of a heat pump for heating and cooling a building according to an exemplary embodiment of the invention.

The refrigerant circuit 100 includes a first heat exchanger 1, a compressor 2, a directional valve 6, which in the present case is designed as a 4/2 directional valve, a second heat exchanger 3, a refrigerant receiver 4, and an expansion element 5, which in the present case is designed as an expansion valve. The individual components of the refrigerant circuit 100 are connected with unspecified refrigerant pipes, wherein a flow direction in the refrigerant circuit 100 for heating the building (heating mode of the heat pump) is indicated with solid arrows and a flow direction for cooling the building (cooling mode of the heat pump) is indicated with dashed arrows. In the heating mode of the heat pump, the first heat exchanger 1 functions as an evaporator and the second heat exchanger 3 as a condenser, and in the cooling mode of the heat pump, the functions of the first and second heat exchangers are reversed.

A temperature sensor 1.1 is fitted in the first heat exchanger 1, and a further temperature sensor 1.3 and a pressure sensor 1.2 are arranged between the first heat exchanger and the compressor 2. A further temperature sensor 2.1 and a further pressure sensor 2.2 as well as a safety high pressure switch 2.3 are arranged upstream of the compressor 2. The temperature and pressure sensors shown may be used in a known manner for open/closed loop controlling and monitoring the expansion element 5 and the compressor 2 during heating and cooling operation of the heat pump.

In a heating mode of the heat pump, gaseous refrigerant flows along the solid arrows from the first heat exchanger 1, in which it has absorbed heat from the ambient air, via the directional valve 6 to the compressor 2.

In the present case, the directional valve 6 has four ports 11, 12, 13, 14 and two different positions, the corresponding flow paths of which are indicated by two solid and two dashed lines. A first port 11 of the directional valve 6 is connected to the second heat exchanger 3 and a second port 12 of the directional valve 6 is connected to the first heat exchanger 1. Furthermore, a third port 13 of the directional valve 6 is connected to an output or a pressure side of the compressor and a fourth port 14 of the directional valve 6 is connected to an input or a suction side of the compressor 2. In the heating mode of the heat pump, the directional valve 6 is in a first position in which the refrigerant flows through it along the two continuous paths (from the second port 12 to the fourth port 14 and from the third port 13 to the first port 11).

The refrigerant is compressed in the compressor and flows as hot gas from the compressor 2 via the directional valve 6 into the second heat exchanger 3, where the refrigerant is liquefied and releases the heat absorbed in the first heat exchanger 1 to a heating/cooling circuit of the building (see arrows VL, RL indicating a flow and a return of the heating/cooling circuit). It is also possible that the second heat exchanger 3 releases the heat absorbed in the first heat exchanger 1 directly to room air in the building by means of a fan. The condensed refrigerant then passes from the second heat exchanger 3 into the refrigerant receiver 4 and from there to the expansion element 5. The refrigerant receiver 4 uses gravity to separate a liquid phase of the refrigerant emerging in two phases from the second heat exchanger 3 from a gaseous phase, thus ensuring that only liquid refrigerant enters the expansion element 5. By means of the expansion element 5, the liquid refrigerant is expanded to an outlet pressure so that it can return to a gaseous state in the first heat exchanger 1 and absorb heat in the process.

For reversing the refrigerant circuit 100, the directional valve 6 may be switched to a second position in which the refrigerant flows through it along the paths marked with dashed lines (from the first port 11 to the fourth port 14 and from the third port 13 to the second port 12). The directional valve 6 takes this position, for example, when the heat pump is in cooling mode, in which the second heat exchanger 3 operates as an evaporator and the first heat exchanger 1 operates as a condenser. In addition, the refrigerant circuit 100 may be reversed if icing of the first heat exchanger 1 is detected in heating mode. Icing may be detected, for example, based on a temperature in the first heat exchanger 1, which may be measured using, for example, the temperature sensor 1.1. In addition to the temperature measurement, a pressure between the first heat exchanger 1 and the compressor 2 may be measured by the pressure sensor 1.2 to detect icing.

When the refrigerant circuit is reversed, e.g. when the heat pump is in cooling mode, gaseous refrigerant flows along the dashed arrows from the second heat exchanger 3, in which it has absorbed heat from the building's heating/cooling system to the compressor 2 via the directional valve 6. In the compressor 2, the refrigerant is compressed and then flows as hot gas via the directional valve 6 into the first heat exchanger 1. In the first heat exchanger 1, the refrigerant is liquefied and releases the heat absorbed in the second heat exchanger 3 into the ambient air. The liquid refrigerant then flows to the expansion element 5, where it is expanded to an outlet pressure so that it can return to a gaseous state in the second heat exchanger 3, thereby absorbing heat.

Conventional directional valves for reversing a refrigerant circuit 100, as described above, usually include a pilot valve which can be used to switch between different flow channels within the directional valve. For this purpose, the directional valve can comprise a valve slider which can be shifted from the first to the second position by means of a pressurization on a respective control surface in order to release different flow channels. In particular, the pilot valve may be a solenoid valve that directs a control refrigerant flow from a high-pressure pipe downstream of the compressor 2 to the respective control surface of the valve slider.

However, such directional valves have the disadvantage that if the pressure difference between an inlet and an outlet of the compressor 2 is too low, the valve slider is not or not fully displaced and the flow channels are consequently not or not fully opened. Exemplary embodiments of a directional valve 6 according to the invention are described below, with which a complete displacement of the valve slider may be carried out independently of the pressure in the refrigerant circuit.

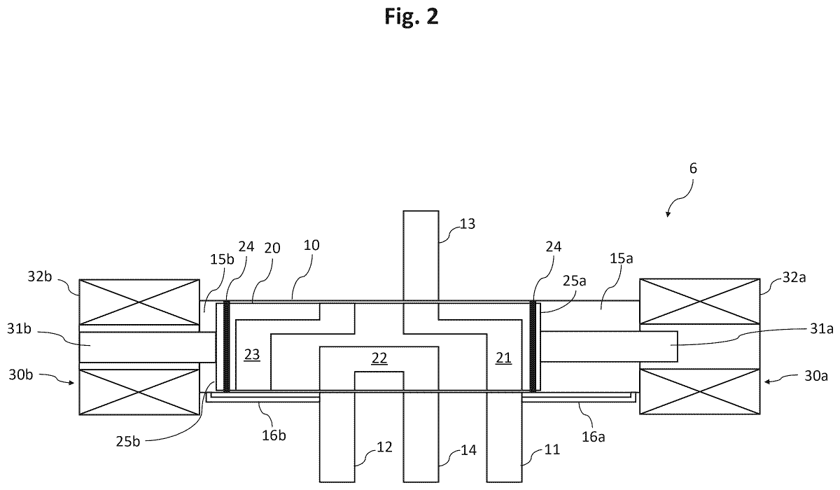

FIG. 2 shows an exemplary embodiment of such a directional valve 6 in a schematic longitudinal sectional view. The directional valve 6 comprises a valve housing 10 with four ports 11, 12, 13, 14, in which a valve slider 20 with three flow channels 21, 22, 23 is axially movably arranged. Each of the four ports has an opening through which refrigerant may enter the valve housing 10 or the flow channels 21, 22, 23 of the valve slider 20. In the present case, the valve slider 20 is designed as a piston slider and the valve housing 10 has a cylinder in its inside, in which the valve slider 20 may move back and forth.

As shown in FIG. 1, the first port 11 may presently be connected to the second heat exchanger 3 and the second port 12 may be connected to the first heat exchanger 1 of the refrigerant circuit 100. The third port 13 may again be connected to the outlet or the pressure side and the fourth port 14 may be connected to the inlet or the suction side of the compressor 2, according to FIG. 1. The third and fourth ports 13, 14 are arranged radially opposite each other on an outer surface of the valve housing 10, and the first and second ports 11, 12 are arranged on the outer surface of the valve housing 10 axially adjacent to the fourth port 14, wherein the fourth port 14 is located between the first and second ports 11, 12.

Among the three flow channels 21, 22, 23 of the valve slider 20, two flow channels 21, 23 serve to connect the first or second heat exchanger 1, 3 to the pressure side of the compressor 2 (high pressure side of the heat pump), while one flow channel 22 is used to connect the other of the two heat exchangers 1, 3 to the suction side of the compressor 2 (low pressure side of the heat pump).

In the present case, a first electromagnet 30a and a second electromagnet 30b, each with a solenoid coil 32a, 32b and an armature 31a, 31b, are attached to both end faces of the valve housing 10. The armature 31a, 31b of each electromagnet 30a, 30b is adjacent to an end face 25a, 25b of the valve slider 20 and is mechanically operatively connected thereto. The valve slider 20 may be moved to the first position by means of the first electromagnet 30a, and the valve slider 20 may be moved to the second position by means of the second electromagnet 30b (switching element).

Moreover, a first chamber 15a is formed in the valve housing 10 adjacent to a first end face 25a of the valve slider 20 and a second chamber 15b is formed in the valve housing 10 adjacent to a second end face 25b of the valve slider 20. The first chamber 15a is connected to the first port 11 by means of a first line 16a, and the second chamber is connected to the second port 12 by means of a second line 16b. The two lines 16a, 16b are designed as capillary tubes. In this way, the first end face 25a of the valve slider 20 is subjected to a pressure that is applied to the first port 11 of the valve housing 10 and the second end face 25b of the valve slider 20 is subjected to a pressure that is applied to the second port 12 of the valve housing 10. Adjacent to each of the two end faces 25a, 25b of the valve slider 20, a seal 24 is provided on its circumference, which seals the first and second chambers 15a, 15b respectively in the valve housing 10.

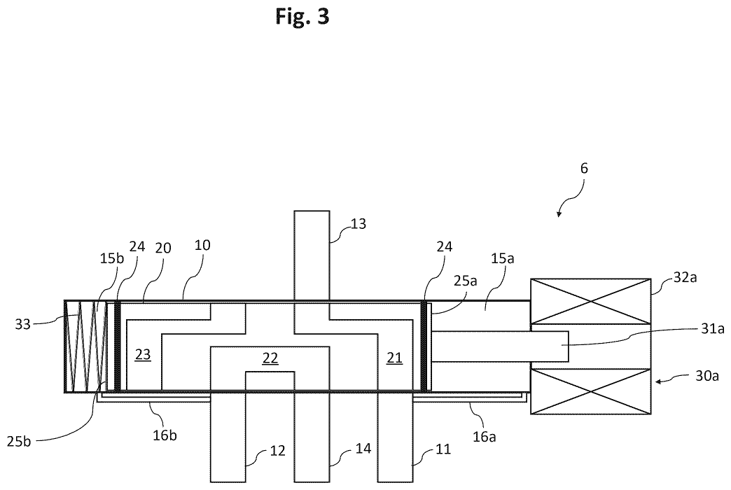

FIG. 3 shows a schematic longitudinal sectional view of a further exemplary embodiment of the directional valve 6, which differs from that shown in FIG. 2 only in the design of the switching element. Instead of the second electromagnet 30b, a spring 33 is arranged adjacent to the second end face 25b of the valve slider 20 in the second chamber 15b of the valve housing 10. The latter may move the valve slider 20 from the first position to the second position when the first electromagnet 30a is switched off and a compressive force acting on the first end face 25a of the valve slider 20 in the first chamber 15a is less than a spring force of the spring 33. It is understood that the spring force must additionally overcome a frictional force between the valve slider 20 and the valve housing 10, which is assumed to be negligible here and in the following.

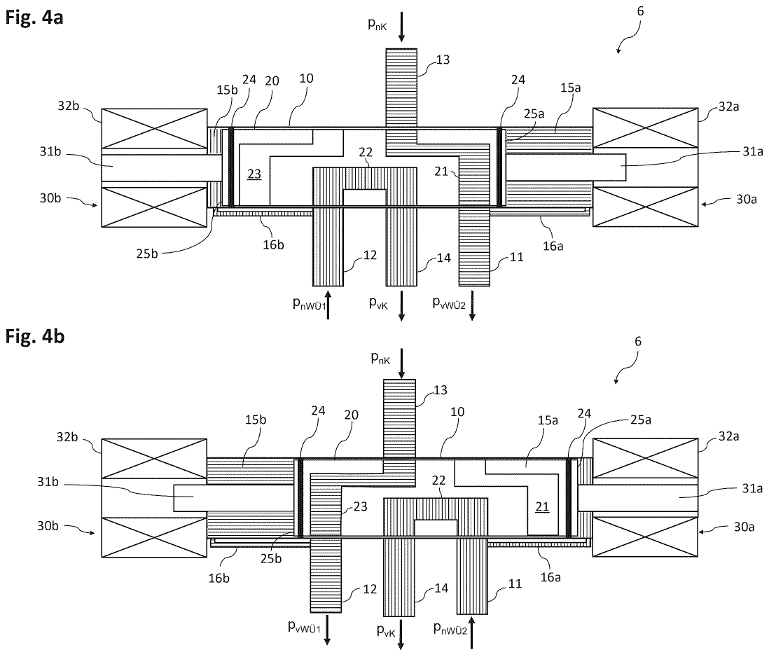

A function of the directional valve 6 shown in FIGS. 2 and 3 is explained in more detail below in connection with FIGS. 4a and 4b. FIG. 4a shows a flow path through the directional valve 6 of FIG. 2 when the valve slider 20 is in the first position, in which the first heat exchanger 1 operates as an evaporator and the second heat exchanger 3 operates as a condenser, and FIG. 4b schematically shows a flow path through the directional valve 6 of FIG. 2 when the valve slider 20 is in the second position, in which the first heat exchanger 1 operates as a condenser and the second heat exchanger 3 operates as an evaporator. To clarify the pressure conditions in the directional valve 6, in both figures all areas in which low pressure prevails are provided with a vertical hatching and all areas in which high pressure prevails are provided with a horizontal hatching.

In order to move the valve slider 20 to the first position shown in FIG. 4a, the solenoid coil 32a of the first electromagnet 30a can be energized, whereby its armature 31a is repelled, thus moving to the left and displacing the adjacent valve slider 20 until a cross-section of the first flow channel 21 is completely released from the openings of the first and third ports 11, 13 and a cross-section of the second flow channel 22 is completely released from the openings of the second and fourth ports 12, 14. In a preferred embodiment, an operating direction of the armatures 31a, 31b may be reversed, i.e. the armatures 31a, 31b may be attracted by the solenoid coils 32a, 32b when energized. In this case, the solenoid coil 32b of the second electromagnet 30b may be energized and its armature 31b moved to the left in order to move the valve slider 20 to the position described above. The armatures 31a, 31b may be mechanically connected to the valve slider 20 for this purpose, for example by means of a screw connection or a weld. It is also possible for the armatures 31a, 31b and the valve slider 20 to be designed in one piece.

In this first position of the valve slider 20, refrigerant flows from the first heat exchanger 1 through the second flow channel 22 of the valve slider 20 to the suction side of the compressor 2 and refrigerant flows from the discharge side of the compressor 2 through the first flow channel 21 of the valve slider 20 to the second heat exchanger 3. Thus, a pressure p_{nWÜ1} is present at the second port 12, which substantially corresponds to a pressure p_{vK} on the suction side of the compressor 2 (low pressure), with which the refrigerant exits the second flow channel 22 via the fourth port 14. In the first position, a pressure p_{vWÜ2} is applied to the first port 11, which essentially corresponds to a pressure p_{nK} on the discharge side of the compressor 2 (high pressure), with which the refrigerant enters the first flow channel 21 via the third port 13. A cross-section of the third flow channel 23 of the valve slider 20 is closed in its first position by the valve housing 10 and is therefore not flowed through by refrigerant.

Since the first port 11 is connected to the first chamber 15a via the first line 16a and the second port 12 is connected to the second chamber 15b via the second line 16b, a high pressure is also present in the first chamber 15a and a low pressure is present in the second chamber 15b when the valve slider 20 is in the first position shown in FIG. 4a.

It becomes apparent that the valve slider 20 is held in the first position solely by the pressure gradient between the first and second chambers 15a, 15b. Accordingly, energization of the solenoid coil 32a of the first electromagnet 30a is only necessary to move the valve slider 20 into the first position and may be switched off as soon as the valve slider 20 has reached this position.

In order to move the valve slider 20 from the first position to the second position, the solenoid coil 32b of the second electromagnet 30b can be energized, whereby its armature 31b moves to the right and displaces the adjacent valve slider 20 until a cross-section of the first flow channel 21 completely covers the openings of the first and third ports 11, 13 and a cross-section of the second flow channel 22 completely covers the openings of the second and fourth ports 12, 14. If the direction of action of the armatures 31a, 31b is reversed, the solenoid coil 32a of the first electromagnet 30a may be energized to move its armature 31a to the right, thereby moving the valve slider 20 mechanically connected to the armatures 31a, 31b to the second position. Alternatively, the spring 3 shown in FIG. 3 may cause the valve slider 20 to move from the first to the second position after the high pressure in the first chamber 15a has been lowered.

In the second position of the valve slider 20, the direction of flow in the refrigerant circuit 100 is reversed and refrigerant flows from the second heat exchanger 3 through the second flow channel 22 of the valve slider 20 to the suction side of the compressor 2 and refrigerant flows from the pressure side of the compressor 2 through the third flow channel 23 of the valve slider 20 to the first heat exchanger 1. Thus, a pressure p_{vWÜ1} is present at the second port 12, which essentially corresponds to a pressure p_{nK} on the pressure side of the compressor 2 (high pressure), with which the refrigerant enters the third flow channel 23 via the third port 13. In the second position, a pressure p_{nWÜ2} is applied to the first port 11, which essentially corresponds to a pressure p_{vK} on the suction side of the compressor 2 (low pressure), with which the refrigerant exits the second flow channel 22 via the fourth port 14. A cross-section of the first flow channel 21 of the valve slider 20 is closed in its second position by the valve housing 10 and is consequently not flowed through by refrigerant.

Since the first port 11 is connected to the first chamber 15a via the first line 16a and the second port 12 is connected to the second chamber 15b via the second line 16b, a low pressure is now present in the first chamber 15a and a high pressure is present in the second chamber 15b. Consequently, in this case the valve slider 20 is held in the second position by the pressure gradient between the second and first chambers 15b, 15a and the second electromagnet 30b can be switched off as soon as the valve slider 20 has reached this position. If a spring 33 is used as a switching element instead of the second electromagnet 30b, its spring force is also only required for the adjustment travel of the valve slider 20, as the pressure gradient between the two chambers subsequently holds the valve slider 20 in the second position. In particular, the spring force may already be supported during the adjustment procedure by a compressive force in the second chamber 15b as soon as part of the cross-section of the third flow channel 23 is released from the openings of the second and third ports 12, 13.

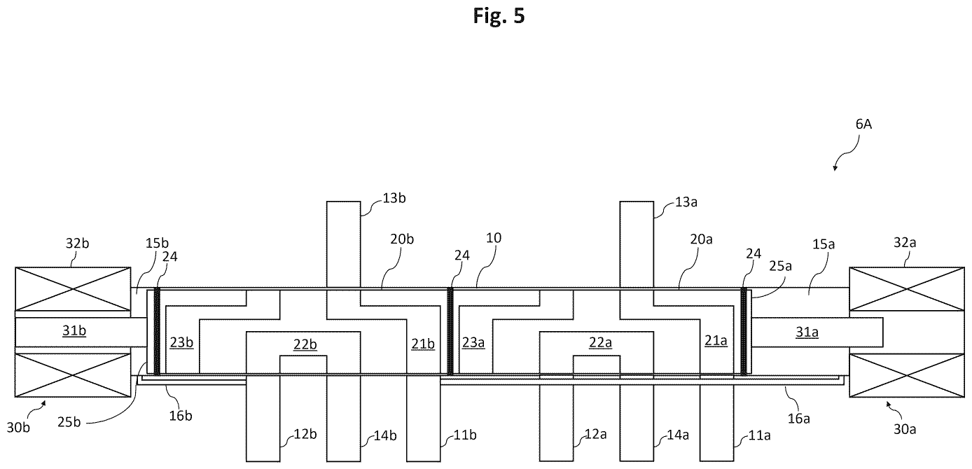

FIG. 5 schematically shows a directional valve 6A according to a further exemplary embodiment of the invention in a schematic longitudinal sectional view. The directional valve 6A comprises a valve housing 10 in which two valve sliders 20a, 20b, each with three flow channels 21a-23a, 21b-23b, are axially movably arranged. Accordingly, in this case eight ports 11a-14a, 11b-14b are arranged on the outer surface of the valve housing 10, of which four ports 11a-14a are assigned to a first valve slider 20a and a further four ports 11b 14b are assigned to a second valve slider 20b. The valve sliders 20a, 20b are of identical design and identical to the valve slider 20 shown in FIG. 2. They adjoin each other at one of their end faces and are arranged next to each other in the longitudinal section of the directional valve 6A shown. In particular, the two valve sliders 20a, 20b are designed as one component, wherein an additional seal 24 is provided on a circumference between the first valve slider 20a and the second valve slider 20b, which fluidically separates their flow channels 21a-23a, 21b-23b from one another.

By means of the directional valve 6A, for example, the flow direction in a refrigerant circuit 100 with two-stage compression and intercooling can be reversed. In particular, the directional valve 6A can be used to reverse a refrigerant circuit as described in EP 24 15 4257.

In case of a refrigerant circuit with two-stage compression and intercooling, a first port 11b of the second valve slider 20b may be connected to the second heat exchanger 3 and a second port 12b of the second valve slider 20b may be connected to the first heat exchanger 1 of the refrigerant circuit 100. A third port 13b of the second valve slider 20b may be connected to an output or a pressure side of a second compressor (not illustrated) and a fourth port 14b of the second valve slider 20b may be connected to an input or a suction side of a first compressor (not illustrated).

In this case, a first inlet 11a of the first valve slider 20a may be connected to a first port of a third heat exchanger (not illustrated), and a second port 12a of the first valve slider 20a may be connected to a second port of the third heat exchanger. The third heat exchanger may be arranged for intermediate cooling of the refrigerant between the first and second compressors. A third port 13a of the first valve slider 20a may be connected to an inlet or a suction side of the second compressor, and a fourth port 14a of the first valve slider 20b may be connected to an outlet or a pressure side of the first compressor.

In case of two-stage compression with intercooling, two of the three flow channels 21b-23b of the second valve slider 10b serve to connect the first or second heat exchanger 1, 3 to the pressure side of the second compressor (high-pressure side of the heat pump), while one flow channel 22b is used to connect the other of the two heat exchangers 1, 3 to the suction side of the first compressor (low-pressure side of the heat pump).

In this case, two of the three flow channels 21a-23a of the first valve slider 10b serve to connect the first or second port of the third heat exchanger to the suction side of the second compressor, while one flow channel 22b is used to connect the other of the two ports of the third heat exchanger to the pressure side of the first compressor.

A first and second electromagnet 30a, 30b, each with a solenoid coil 32a, 32b and an armature 31a, 31b, are attached to both end faces of the valve housing 10, analogous to the directional valve 6 shown in FIG. 2. The armature 31a of the first electromagnet 30a is adjacent to a first end face 25a of the first valve slider 20a and the armature 31b of the second electromagnet is adjacent to a second end face 25b of the second valve slider 20b. In this way, the first and second armatures 31a, 31b are mechanically operatively connected to the valve sliders 20a, 20b, which are designed as a common component. By means of the first electromagnet 30a, the two valve sliders 20a, 20b may be moved together to the first position, and by means of the second electromagnet 30b (switching element), the two valve sliders 20a, 20b may be moved together to the second position.

In the directional valve 6A, the first chamber 15a in the valve housing 10 adjoins the first end face 25a of the first valve slider 20a, and the second chamber 15b adjoins the second end face 25b of the second valve slider 20b. In the present case, the first chamber 15a is connected to the first port 11b of the second valve slider 20b by means of the first line 16a, and the second chamber 15b is connected to the second port 12b of the second valve slider 20b by means of the second line 16b. In this way, the two valve sliders 20a, 20b of the directional valve 6A are both held in the first and second positions respectively, in each of which there is a pressure gradient between the two chambers 15a, 15b.

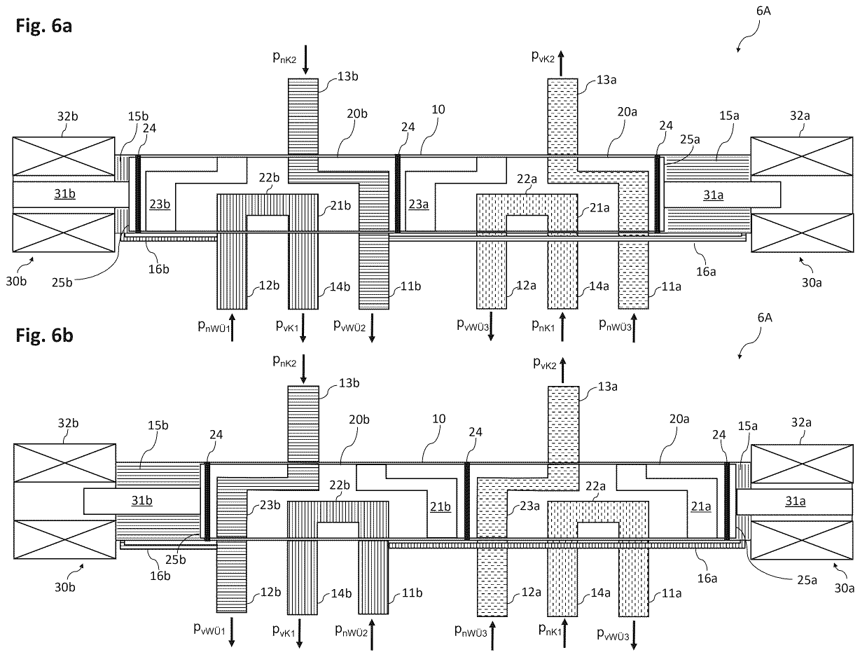

A function of the directional valve 6A shown in FIG. 5 is explained below in connection with FIGS. 6a and 6b for a refrigerant circuit 100 with two-stage compression and intercooling, to which the directional valve 6A is connected as described above.

As already described above, such a refrigerant circuit 100 may comprise, in addition to the elements illustrated in FIG. 1, a first and a second compressor (not illustrated) and a third heat exchanger (not illustrated) arranged between the first and second compressors. By means of the first compressor, the refrigerant may be compressed to a medium pressure and cooled in the third heat exchanger. As a result, the refrigerant reaches the second compressor at a lower temperature, in which it is compressed to the desired high pressure before entering the heat exchanger 1, 3, each of which operates as a condenser. In this way, a too high temperature after complete compression of the refrigerant may be avoided and the efficiency of the compression improved.

In particular, FIG. 6a shows flow paths through the directional valve 6 of FIG. 5 when the valve slider 20 is in the first position, in which the first heat exchanger 1 operates as an evaporator and the second heat exchanger 3 operates as a condenser, and FIG. 6b schematically shows flow paths through the directional valve 6 of FIG. 5 when the valve slider 20 is in the second position, in which the first heat exchanger 1 operates as a condenser and the second heat exchanger 3 operates as an evaporator.

To illustrate the pressure conditions in the directional valve 6, in both figures all areas in which low pressure (pressure at the inlet of the first compressor) prevails are provided with a vertical hatching and all areas in which high pressure (pressure at the outlet of the second compressor) prevails are provided with a horizontal hatching. In addition, the flow channel 22a of the first valve slider 20a, through which the refrigerant flows at the medium pressure from the first compressor to the third heat exchanger, is provided with a dashed vertical hatching and the flow channels 21a, 23a of the first valve slider 20a, through which the refrigerant flows at the medium pressure from the third heat exchanger to the second compressor, are provided with a dashed horizontal hatching.

In order to move the two valve sliders 20a, 20b to the first position shown in FIG. 6a, the solenoid coil 32a of the first electromagnet 30a may be energized, causing its armature 31a to be repelled, thus moving to the left and displacing the adjacent valve sliders 20a, 20b until their first flow channels 21a, 21b are completely released through the openings of the first and third ports 11a, 11b, 13a, 13b and their second flow channels 22a, 22b are completely released through the openings of the second and fourth ports 12a, 12b, 14a, 14b of the respective valve slider 20a, 20b. In the first position, the third flow channels 23a, 23b of the two valve sliders 20a, 20b are closed by the valve housing 10. In a preferred embodiment, an operating direction of the armatures 31a, 31b may be reversed, i.e. the armatures 31a, 31b may be attracted by the solenoid coils 32a, 32b when energized. In this case, the solenoid coil 32b of the second electromagnet 30b may be energized and its armature 31b moved to the left in order to move the valve sliders 20a, 20b to the position described above. For this purpose, the armatures 31a, 31b may be mechanically connected to the valve sliders 20a, 20b, for example by means of a screw connection or a weld. It is also possible that the armatures 31a, 31b and the valve sliders 20a, 20b are designed in one piece.

In this first position of the valve sliders 20a, 20b, refrigerant flows from the first heat exchanger 1 through the second flow channel 22b of the second valve slider 20b to the suction side of the first compressor and refrigerant flows from the pressure side of the second compressor through the first flow channel 21b of the second valve slider 20b to the second heat exchanger 3. Thus, the pressures applied to the ports 11b-14b correspond to those explained in FIG. 4a and are not described again here. Furthermore, refrigerant flows from the discharge side of the first compressor via the second flow channel 22a of the first valve slider 20a to the third heat exchanger and refrigerant flows from the third heat exchanger via the first flow channel 21a of the first valve slider to the suction side of the second compressor. A pressure p_{WÜ3}, p_{vK2}, at the first, second and third ports 11a, 12a, 13a of the first valve slider 20a essentially corresponds to a pressure p_{nK1}, which is present on the pressure side of the first compressor to which the fourth port 14a of the first valve slider 20a is connected (mean pressure p_{nK1}=p_{WÜ3}=p_{vK2}).

Since the first port 11b of the second valve slider 20b is connected to the first chamber 15a via the first line 16a and the second port 12b of the second valve slider 20b is connected to the second chamber 15b via the second line 16b, there is a pressure gradient between the first and second chambers 15a, 15b, which holds the valve sliders 20a, 20b, which are designed as a common component, in the first position, even if the first electromagnet 30a is switched off.

In order to move the valve sliders 20a, 20b from the first position to the second position, the solenoid coil 32b of the second electromagnet 30b may be energized, causing its armature 31b to move to the right and displace the adjacent valve sliders 20a, 20b until their third flow channels 23a, 23b are completely released through the openings of the second and third ports 12a, 12b, 13a, 13b and their second flow channels 22a, 22b are completely released through the openings of the first and fourth ports 11a, 11b, 14a, 14b of the respective valve slider 20a, 20b. If the direction of action of the armatures 31a, 31b is reversed, the solenoid coil 32a of the first electromagnet 30a may be energized to move its armature 31a to the right, thereby moving the valve slider 20a, 20b mechanically connected to the armature to the second position. Alternatively, the spring 3 shown in FIG. 3 may cause the valve sliders 20a, 20b to move from the first to the second position after the high pressure in the first chamber 15a has been lowered. The first flow channels 21a, 21b of the two valve sliders 20a, 20b are closed in the first position by the valve housing 10.

In the second position of the valve slides 20a, 20b, the direction of flow in the refrigerant circuit 100 is reversed and refrigerant flows from the second heat exchanger 3 through the second flow channel 22b of the second valve slide 20b to the suction side of the first compressor and refrigerant flows from the pressure side of the second compressor through the third flow channel 23b of the second valve slide 20b to the first heat exchanger 1. The pressures applied to the connections 11b-14b therefore correspond to those explained in FIG. 4b and are not described again here.

Furthermore, refrigerant flows from the discharge side of the first compressor via the second flow channel 22a of the first valve slider 20a to the third heat exchanger, wherein a flow direction in the second flow channel 22a is reversed compared to the first position of the valve sliders 20a, 20b. In addition, refrigerant flows from the third heat exchanger via the third flow channel 23a of the first valve slider 20a to the suction side of the second compressor. A pressure p_{WÜ3}, p_{vK2}, at the first, second and third ports 11a, 12a, 13a of the first valve slider 20a also essentially corresponds here to a pressure p_{nK1}, which is present on the pressure side of the first compressor to which the fourth port 14a of the first valve slider 20a is connected (mean pressure p_{nK1}=p_{WÜ3}=p_{vK2}).

Since the first port 11 is connected to the first chamber 15a via the first line 16a and the second port 12 is connected to the second chamber 15b via the second line 16b, a pressure gradient is now present between the second and first chambers 15b, 15a, which holds the valve sliders 20a, 20b, designed as a common component, in the second position, even if the second electromagnet 30b is switched off. If a spring 33 is used as a switching element instead of the second electromagnet 30b, its spring force is also only required for the adjustment travel of the valve sliders 20a, 20b, since the pressure gradient between the two chambers 15a, 15b subsequently holds them in the second position. In particular, the spring force may already be supported by a compressive force in the second chamber 15b during the adjustment procedure as soon as a part of a cross-section of the third flow channel 23b in the second valve slider 20b is released from the openings of the second and third ports 12b, 13b.

The examples described above clearly show that by means of the directional valve 6, 6A, a reliable and efficient refrigerant circuit reversal in a heat pump can be achieved. In particular, the refrigerant circuit reversal can also be carried out with a stopped compressor 2, since no refrigerant pressure is required to adjust the valve slider 20, 20a, 20b. The use of two valve sliders 20a, 20b in a valve housing 10 further allows multiple switching functions to be realised with only one directional valve 6A.

1. A directional valve (6) for a heat pump for heating and cooling a building, comprising
a valve housing (10) with a plurality of ports (11, 12, 13, 14);
a valve slider (20) with a plurality of flow channels (21, 22, 23), which is arranged axially movable in the valve housing (10);
at least one electromagnet (30a) with an armature (31a) which is mechanically operatively connected to the valve slider (20), wherein the electromagnet (30a) is configured to move the valve slider (20) into a first position;
a switching element configured to move the valve slider (20) to a second position;
a first line (16a) connecting a first chamber (15a), which is formed adjacent to a first end face (25a) of the valve slider (20) in the valve housing (10), to a first port (11) of the valve housing (10); and
a second line (16b) connecting a second chamber (15b), which is formed adjacent to a second end face (25b) of the valve slider (20) in the valve housing (10), to a second port (12) of the valve housing.

2. The directional valve (6) according to claim 1, wherein a third port (13) of the valve housing (10) is connectable to a high-pressure side, and a fourth port (14) of the valve housing (10) is connectable to a low-pressure side of the heat pump.

3. The directional valve (6) according to claim 2, wherein the valve slider (20) when in the first position is configured to connect the first port (11) of the valve housing (10) to the high pressure side and the second port (12) of the valve housing (10) to the low pressure side of the heat pump.

4. The directional valve (6) according to claim 3, wherein the valve slider (20) when in the second position is configured to connect the first port (11) of the valve housing (10) to the low pressure side and the second port (12) of the valve housing (10) to the high pressure side of the heat pump.

5. The directional valve (6) claim 1, wherein the switching element comprises an electromagnet (30b) or at least one spring (33).

6. The directional valve (6) according to claim 1, wherein the valve slider (20) is formed as a piston slider.

7. The directional valve (6) according to claim 1, wherein the valve slider (20) has three flow channels (21, 22, 23).

8. The directional valve (6) according to claim 1, wherein one or more seals (24) are arranged on the valve slider (20), which seal the first and second chambers (15a, 15b) in the valve housing (10).

9. The directional valve (6A) according to claim 1, wherein at least two valve sliders (20a, 20b) are arranged in the valve housing.

10. The directional valve (6A) according to claim 9, wherein the at least two valve sliders (20a, 20b) have a common center axis and are adjacent to each other with one of their end faces.

11. The directional valve (6A) according to claim 9, wherein the flow channels (21a-23a, 21b-23b) of the at least two valve sliders (20a, 20b) are fluidically separated from each other by means of at least one seal (24).

12. The directional valve (6A) according to claim 9, wherein the at least two valve sliders (20a, 20b) are connected to each other.

13. The directional valve (6A) according to claim 9, wherein the at least two valve sliders (20a, 20b) are configured to be moved to the first position by a common electromagnet and to the second position by a common switching element.

14. The directional valve (6A) according to claim 9, wherein the at least two valve sliders (20a, 20b) are formed as a common component.

15. A method for reversing a flow direction in a refrigerant circuit (100) of a heat pump for heating and cooling a building by means of a directional valve (6, 6A) according to claim 1, comprising the steps of:
activating an electromagnet (31a) or a switching element of the directional valve (6, 6A) if a demand for reversing the flow direction is detected; and
deactivating the electromagnet (31a) or the switching element when a valve slider (20) of the directional valve (6, 6A) has moved to a first or a second position.

16. The method according to claim 15, wherein the electromagnet (31a) or the switching element is activated at standstill of a compressor (2) of the refrigerant circuit (100) in order to move the valve slider (20) to the first or the second position.

17. A heat pump for heating and cooling a building, comprising:
at least one refrigerant circuit (100) with a first heat exchanger (1), a compressor (2), a second heat exchanger (3), an expansion element (5); and
a directional valve (6, 6A) according to claim 1.
